(19) United States
(12) Patent Application Publication
(10) Pub. No.: US 2011/0150414 A1
(43) Pub. Date: Jun. 23, 2011

(54) DVR Base Device with Portable Media Player

(76) Inventors: Peter Garrett, Aptos, CA (US); Mark A. Boys, Aromas, CA (US)

(21) Appl. No.: 12/972,022

(22) Filed: Dec. 17, 2010

Related U.S. Application Data
(60) Provisional application No. 61/287,598, filed on Dec. 17, 2009.

(51) Int. Cl. H04N 5/775

(52) U.S. Cl. 386/230; 386/E05.003

(57) ABSTRACT

A portable media player (PMP) has non-volatile memory, at least one communication interface to remote digital devices, a touchscreen, and software stored on and executing from a machine-readable physical medium. The software provides functionality to enable a user, via touchscreen controls, with the PMP coupled to a digital video recorder (DVR), to browse indicators of video files stored on the DVR, to select and download files to the non-volatile memory of the PMP, and to play the video files on the touchscreen of the PMP after the PMP is uncoupled from the DVR.

### BACKGROUND OF THE INVENTION

1. Field of the Invention

The present invention is described generally, as pertaining to the field of digital video recording (DVR) devices.

2. Description of Related Art

DVR technology has become increasingly popular in the consumer market, allowing users to download their favorite television programs to watch at a later date, when it is more convenient for the user. DVR technology is widely known to the consumer electronics industry, being utilized by businesses and home enthusiasts alike, to record and review television programming, video surveillance and various other forms of music and photographic media formats.

One problem with current DVR technology is, current devices available to the market, do not allow the user(s) to transport their recorded television programs digitally, outside of their home. Also, current DVR technologies do not encompass enough features, which offer the user a dynamic multimedia experience.

It has occurred to the inventors that a means for transporting and viewing recorded television content seamlessly, at another location, is needed. Thereby, portability allows the user(s) to have more control over their recorded program(s), with a more dynamic multimedia experience. It has also occurred to the inventors that a complete multimedia experience currently involves an excessive plurality of separate devices (often with incompatible manufacturer brands and/or proprietary media formatting). The inventors seek to simplify the multimedia experience by combining several multimedia devices into one portable media player (PMP), thus streamlining the portability of the multimedia content, which may be captured to a DVR Base Device.

While DVR technology has improved the convenience of television watching, many consumers believe there are still improvements that need to be made to DVR technology. In order to give the user more flexibility as to how, when, and where they may view their recorded television programs, which may be recorded/stored on the DVR or PMP device. The market for a new approach is evident.

### BRIEF SUMMARY OF THE INVENTION

In an embodiment of the invention a portable media player (PMP) is provided comprising non-volatile memory, at least one communication interface to remote digital devices, a touch screen, and software stored on and executing from a machine-readable physical medium. The software provides functionality to enable a user, via touch screen controls, with the PMP coupled to a digital video recorder (DVR), to browse indicators of video files stored on the DVR, to select and download files to the non-volatile memory of the PMP, and to play the video files on the touch screen of the PMP after the PMP is uncoupled from the DVR.

### BRIEF DESCRIPTION OF THE SEVERAL VIEWS OF THE DRAWINGS

FIG. 1 is an oblique frontal perspective view of a DVR base device with a PMP device, according to one embodiment of the present invention.

FIG. 2 is an oblique rearward perspective view of a DVR base device with a PMP, according to one embodiment of the present invention.

FIG. 3 is an oblique left side elevation perspective view of a DVR base device with a PMP, according to one embodiment of the present invention.

FIG. 4 is an oblique frontal perspective view of a PMP device of FIG. 1, according to one embodiment of the present invention.

FIG. 5 is an oblique right side perspective view of a PMP device of FIG. 4, according to one embodiment of the present invention.

FIG. 6 is an illustration of a PMP device of FIG. 4, being used as a universal remote control, according to one embodiment of the present invention.

FIG. 7 is an illustration of a PMP device being used as a handheld control interface for a video gaming component of the DVR base device of FIG. 1, according to another embodiment of the present invention.

FIG. 8 is an illustration of a PMP device being used as a video game controller to play a video game on a DVR base device connected television, according to one embodiment of the present invention.

FIG. 9 is an isometric view of a PMP device of FIG. 4 with accompanying Aftermarket Dock, according to one embodiment of the present invention.

FIG. 10 is an oblique frontal perspective view of a DVR base device that may comprise a fixed screen and separate PMP Device, according to one embodiment of the present invention.

FIG. 11 is an oblique frontal perspective view of a DVR base device of FIG. 10 that may comprise a fixed screen, and may not comprise a wireless antennae or an internal router, according to one embodiment of the present invention.

FIG. 12 is an oblique rearward perspective view of a DVR base device of FIG. 11, according to one embodiment of the present invention.

### DETAILED DESCRIPTION OF THE INVENTION

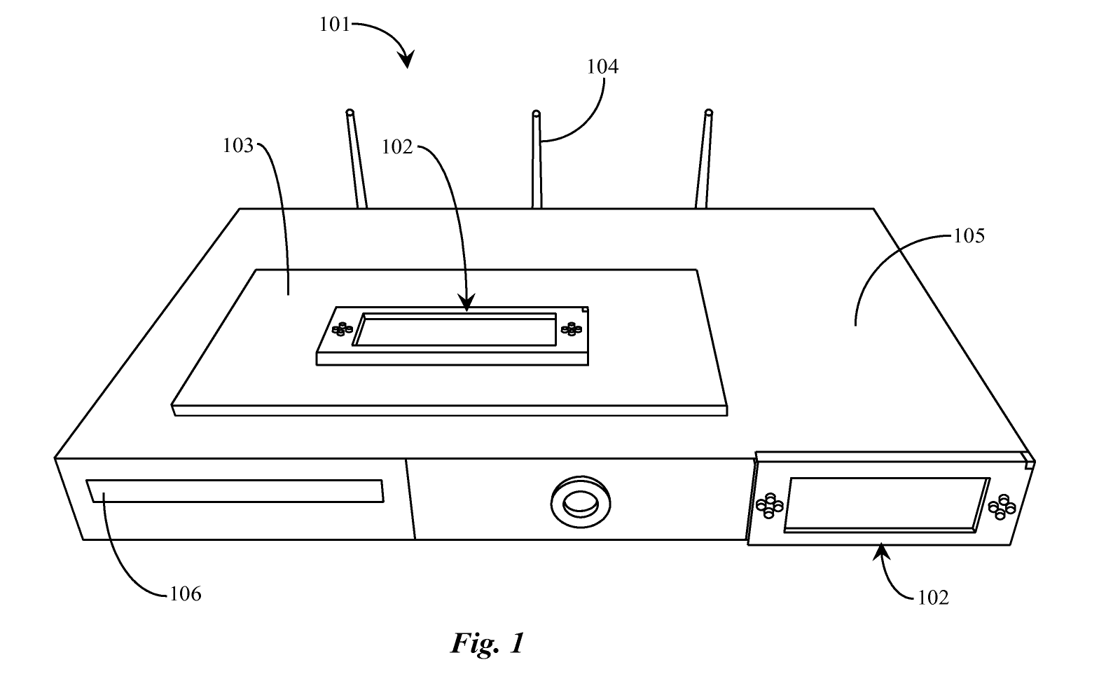

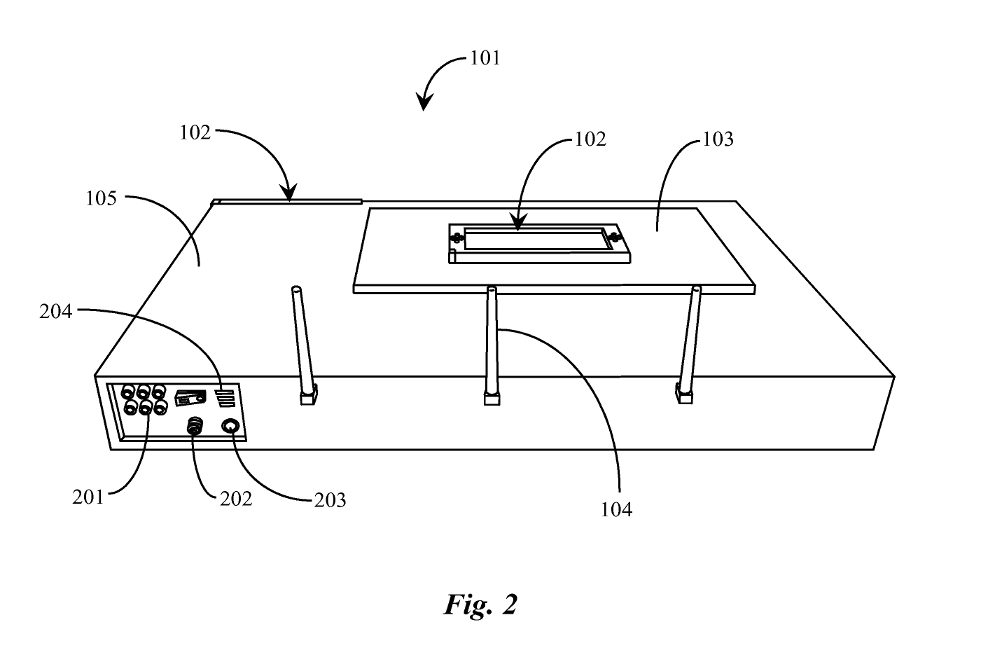

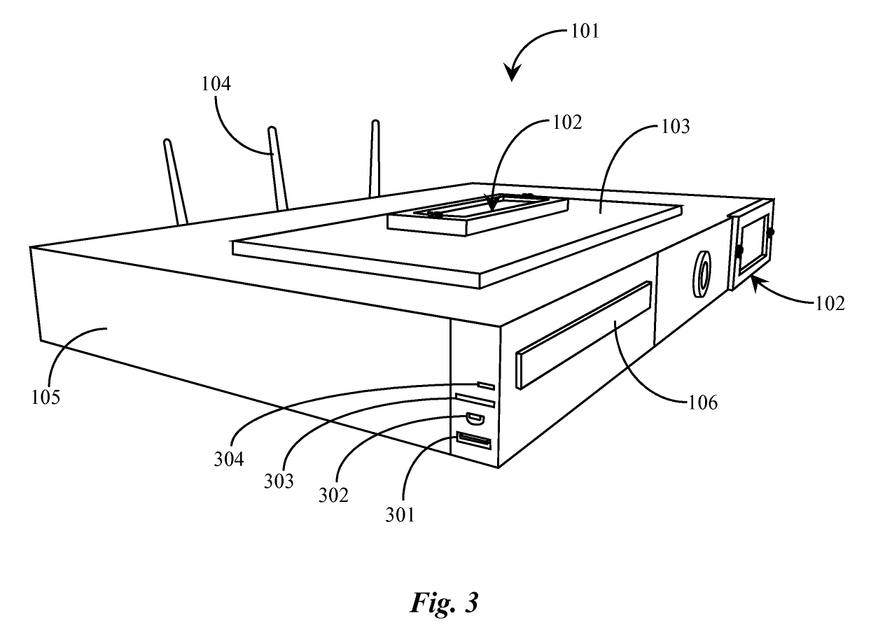

FIG. 1, in conjunction with FIGS. 2 and 3, illustrate a DVR base device 101, according to one embodiment of the present invention. The DVR base device may be a stationary device and may comprise several electronic components and electronics boards that are housed in an Electronics Enclosure element 105, as is common in the consumer electronics industry. The DVR base device may also be wirelessly connected to the user's computer to allow web content, such as YouTube, Hulu or Netflix Online, for a few examples that are well known to the internet video media industry, and may be streamed to the DVR base device or through the base device to the user's television. This may be accomplished utilizing an incorporated wireless router 104 that wirelessly interacts with an ISP, therefore allowing a shared connection to a user's computer(s) and the internet.

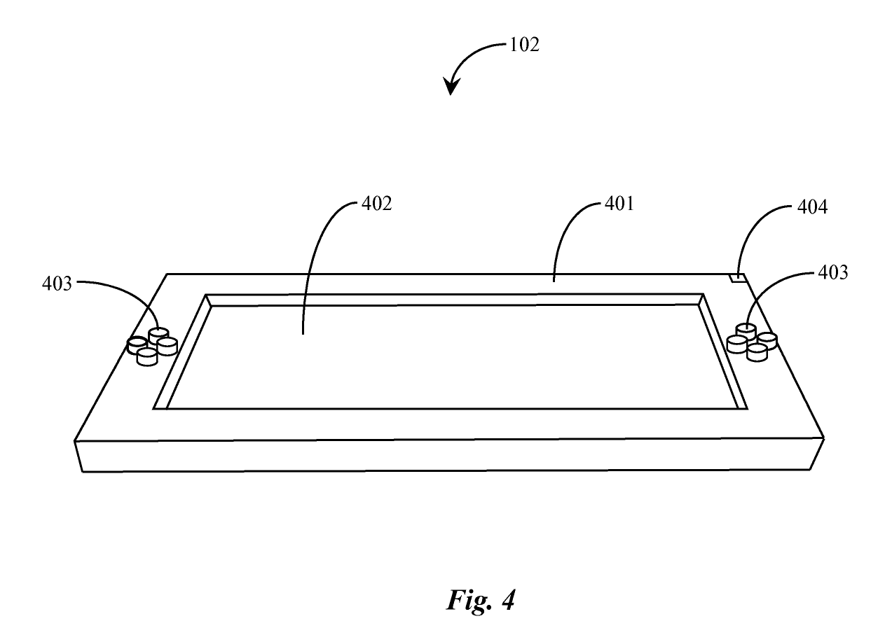

Also illustrated in FIGS. 1 and 2, the DVR base device may comprise a PMP device 102, a handheld unit that may wirelessly connect to and/or dock with the DVR base device. The PMP device may comprise an internal wireless transceiver, such as Bluetooth, UWB, ZigBee or many other wireless spread spectrum, for connecting to and communicating with the DVR base device. A user may eject the PMP device from the DVR base device, via an eject button element 404 (as illustrated in FIG. 4), from a docking port (not shown) provided on the electronics enclosure. The PMP device may comprise an internal battery (not shown) that may be charged or recharged when docked with the DVR base device. When docked with the DVR base device, the PMP device may act as a viewable interface that allows the user to view/preview and/or select content stored on the DVR base device, without disrupting television content currently being viewed. This function may also be used when the PMP device is not docked with DVR base device, via the wireless interface of the device.

The DVR base device may comprise a multimedia disc player 106 (as illustrated in FIGS. 1, 3, 10 and 11), such as CD-R/W, DVD, DVD-R, Blu-Ray, HD-DVD or various other multimedia disc formats, well known in the industry. Therefore, allowing a user to play/record digital multimedia content to/from the hard drive element (not shown) of the DVR base device, to a more permanent storage media, according to one embodiment of the present invention.

Several PMP devices may be paired with the DVR base device to allow for recorded content customization, by different users. In one embodiment, each user will be able to custom program their PMP Device thereby, recording only the television programs they want to watch. When a user transports the PMP Device, only their customized content is available on that particular PMP Device and not all the recorded programs from all the users, who use the DVR base device. In one embodiment, the user is able to customize the screen of their PMP Device to display name, personal photographs, downloaded graphics, custom themes/colors/wallpapers, etc. The PMP Device may have its own internal memory (not shown) and internal/external control elements for managing, navigating and selecting stored/recorded content. The PMP Device may also contain a Touch Screen 402 that may allow the user to search for content and input text, via a virtual keyboard. The PMP Device may also allow the user to interact with television shows, in a manner such as rating their shows, television shopping, game show participation, reality TV voting, gambling, or interactive adventures and cartoons, via the touch screen or tactile controls elements 403. In this way, the television may become a platform as robust as the internet and may provide the industry with several new business/revenue models.

In other embodiments of the present invention, the user's Smartphone may wirelessly pair with the DVR base device of FIG. 1 to stream or download content recorded and/or stored on the user's Smartphone to the DVR base device, or from the DVR base device to the user's Smartphone. For example, a user may pair the DVR base device to their smartphone and view recorded content from the DVR base device on their smartphone. In addition, the DVR base device may comprise software that allows the user to download the stored content to their Smartphone, enabling the smartphone to remotely control the DVR base device. Essentially, this enables the user's smartphone (not shown) to become a portable media player device.

According to one embodiment of the present invention, a user may load recorded television programs and/or video to the DVR base device from an external data source such as a portable hard drive, compact flash card or SD card, well known to the digital multimedia compact storage device industry, or the user may be connect an external video source to the DVR base device, such as a video camera, digital camera or portable hard drive, for a few examples. These devices may interface with the DVR base device, via a USB port 301, a mini USB port 302, a compact flash card Slot 303 or a SD card Slot 304 as is illustrated in FIG. 3.

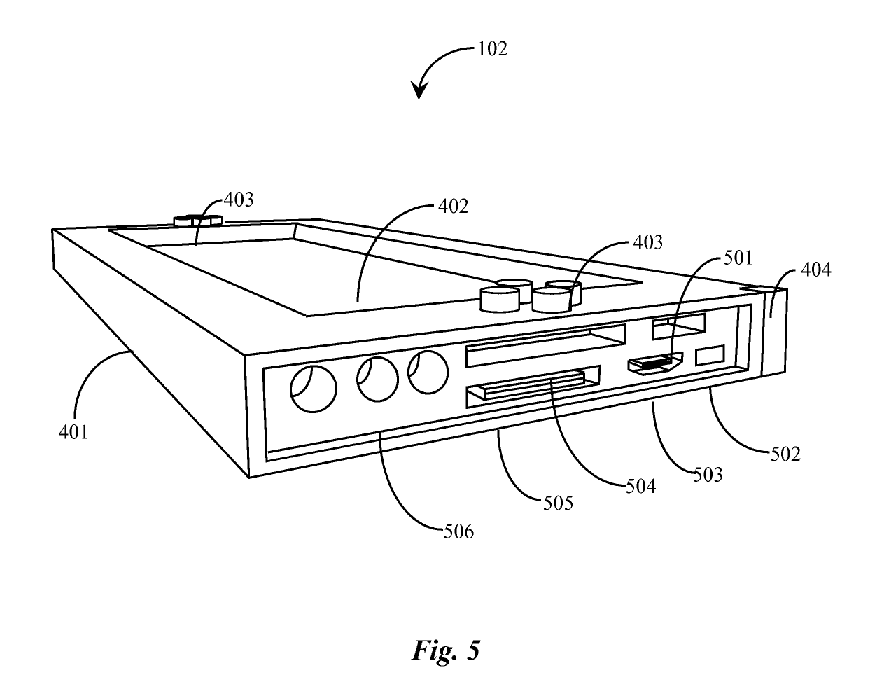

FIG. 5 is an oblique right side perspective view of a PMP device of FIG. 4. The PMP device 102 may pair with a television or other device equipped with Bluetooth, Certified Wireless USB, UWB, or a variety of other viable wireless spread spectrum, via a Wireless Transmitter element 506. Wireless communication technology may afford a user the ability to view and/or interact with programs and/or videos from an external source (such as a portable hard drive, compact flash, SD card, etc.), or connect the PMP device to an external video storage source/device (such as a video camera, digital camera or portable hard drive, for a few examples. Components incorporated into the PMP device's electronics enclosure element 401, such as a USB Port 505, a mini USB Port 503, a compact flash card Slot 504, an SD card slot 501 or various other viable connection standards well known to the artisan, may provide the primary means for this type of transfer technology, according to one embodiment of the present.

In another embodiment of the present invention, the PMP device may receive prompts, engaging the user to receive samples, or make purchases of goods or services advertised during commercial breaks or embedded within television programs, thereby affording advertisers/retailers with a new business/revenue model. In one example, the user may be able to purchase an outfit, clothing, shoes and/or accessories that a character is wearing in a television program. In another example, the user may be able to purchase tickets for an upcoming concert, stage play, sporting event, etc. advertised during a commercial break. In yet another example, a user may be prompted to play a mini-game and receive a product sample, upon reaching a pre-determined score.

In one embodiment of the present invention, the DVR base device may comprise retractable television connections, such as an S-Video 203, a coaxial cable 202 , RCA Connectors 201, HDMI interfaces 204 (as illustrated in FIG. 2), or any other video/audio connection standard, well known to the artisan. In another embodiment, television connections may be separate cables stored in a case that the user can place the PMP device into, to protect it when transporting it from one location to another.

In another embodiment, portable DVR device may connect to the internet via pairing the base DVR device and/or in-home Wi-Fi and act as both an Interactive TV Guide and a universal remote control. When used as an embodiment of an Interactive TV Guide, a user may be able to view television program schedules, preview clips of television programs, set recording function and receive program suggestions via the PMP device's touch screen element 402. This may allow the PMP device to prompt the user as to when a show, that they have previously watched, may air again. Also, it may prompt a user of any tie-ins, crossovers, or guest appearances by actors, within other television programs.

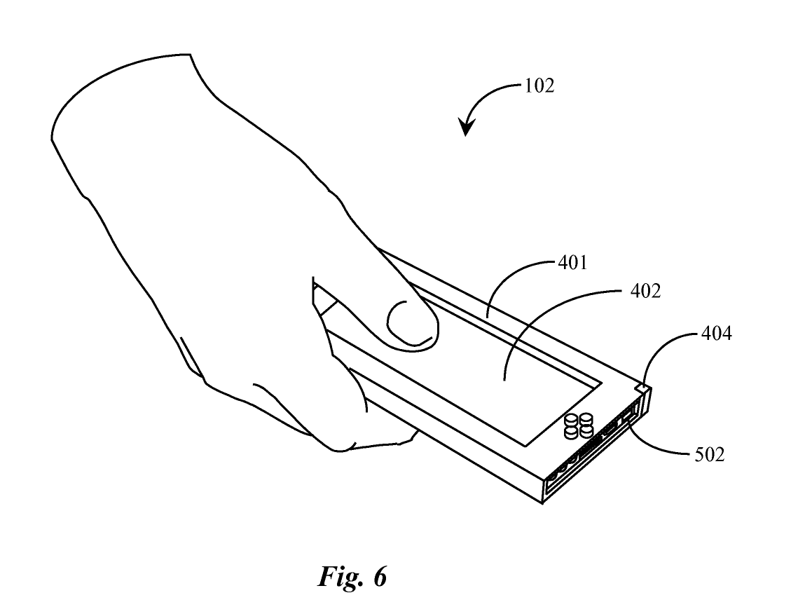

FIG. 6 is an illustration of a PMP device of FIG. 4, being used as a universal remote control, according to one embodiment of the present invention. The user may be able to program the PMP device to communicate with multiple electronic devices, such as televisions, stereos, DVD players, home automation systems, or any other device(s) and/or system(s) that may be remotely controlled, via an Infrared Diode Lens 502. The user may wirelessly connect to the internet with the PMP device and search for the electronic device's model number, which they wish to control, and acquire the correct codes for controlling that particular device. A user may also search according to the device's brand name and toggle through a list of codes, until they find the code that controls their device. In one example, when the PMP device is used in the embodiment of a universal remote control, the PMP device(s) may be programmed to show a particular user's favorite channels on their PMP device and another user's favorite channels, on a separate device. In another example, when used in the embodiment of a universal remote control, the logos of the television stations may be displayed as virtual buttons on the portable DVR device's touch screen instead of numbers. In another example, video thumbnails of programming currently being played on the channel may be displayed instead of television station logos. A user would be able to scroll through the video thumbnails and zoom in on them to check the programming currently being played on the channels, without manually flipping channels on the television.

In one embodiment, the PMP device may be used as a touch screen internet tablet (not depicted in the body of this disclosure), which the user may be able to use for quick access to the internet, while watching television.

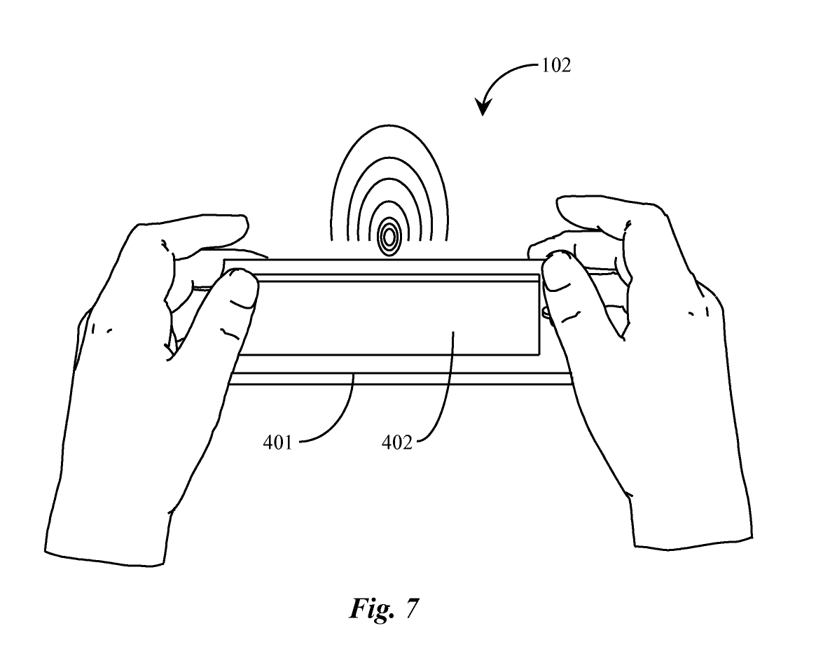

In one embodiment, the portable DVR device may also be a handheld video gaming system, which may allow for a user to play video games as in a manner similar to handheld systems (as illustrated in FIG. 7 of this disclosure), such as Nintendo DS, PlayStation portable or mobile phone gaming, well known to the portable gaming industry.

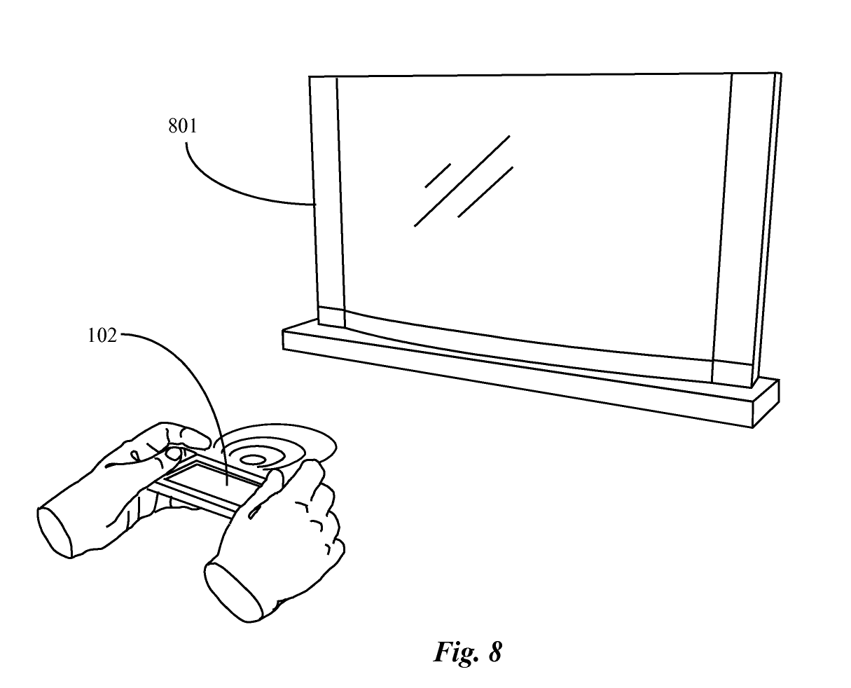

In another embodiment, the PMP Device 102 may also be a video game controller, which may interact wirelessly to a comparably equipped Wireless HDTV system 801(as illustrated in FIG. 8 of this disclosure), affording a user interactive video gaming experience, provided by or purchased from their cable television provider. This may allow cable providers to get into the video game distribution market, thus providing new marketing opportunities. It may also do away with the need to purchase a separate video game console, physical media or the delay in acquiring new game content. This will also allow for video game developers to update an existing video game with new levels, characters, content, weapons, power ups, etc.) In one embodiment, when used as a video game controller, the PMP device may also allow multiple users to display stats, spells and combos for their games privately on the PMP device's screen. It should be noted, this is not achievable with multiple players on current video game systems. By allowing cable providers to enter the video gaming distribution market, cable providers may also be able to offer an outlet for the distribution of custom niche or independent video games, without the high initial start-up costs, that are common to video game developers today.

In one embodiment of the present invention, the PMP device may allow the user to transport their stored/recorded content for viewing at another location or while in transit. The PMP device 102 may be paired wirelessly to the DVR base device, or it may be connected via USB port, a specially designed data docking port, or it may share content via memory card slots. The PMP device's internal battery may be automatically charged when connected to the Base DVR device, or it may be charged via magnetic induction charging plate 103 (as illustrated in FIGS. 1, 2, 3, 10, 11 and 12). In another embodiment, electronic devices such as cellular phones, Bluetooth earpieces, MP3 players or GPS units, equipped with magnetic induction charging technology, may also be charged by placing them on the magnetic induction charging plate.

In one embodiment, the DVR base device 101 may comprise wireless antennae 104 (as illustrated in FIGS. 1, 2, 3 and 10) that are connected to an internal router that may wirelessly interface the DVR base device to the internet, via an in-house WLAN connection, thus doubling as the user's wireless in-home router. In one embodiment, the user may utilize the DVR base device as a router for connecting all multimedia devices, such as PC's, laptops, MP3 players, internet tablets, for examples to the internet. In one embodiment, rather than transport their recorded television programs, via the PMP device 102, the user would record their programs to the DVR base device, then remotely access their recorded programs through the internet by going to a designated website. A user would enter their username and password to access their online account, gaining access to their stored/recorded content. In another embodiment, user would be able to access their online account via the method described above and be able to set the recording function of the DVR base device from the internet or the user's smartphone. According to one embodiment, the DVR base device and the PMP device(s) may be wirelessly paired and communicate with each other via Bluetooth, Certified Wireless USB, UWB, or any other viable wireless spread spectrum.

In another embodiment, all the aforementioned embodiments are integrated into a Flat Screen HDTV, which may afford a user extreme ease of use, without any additional components.

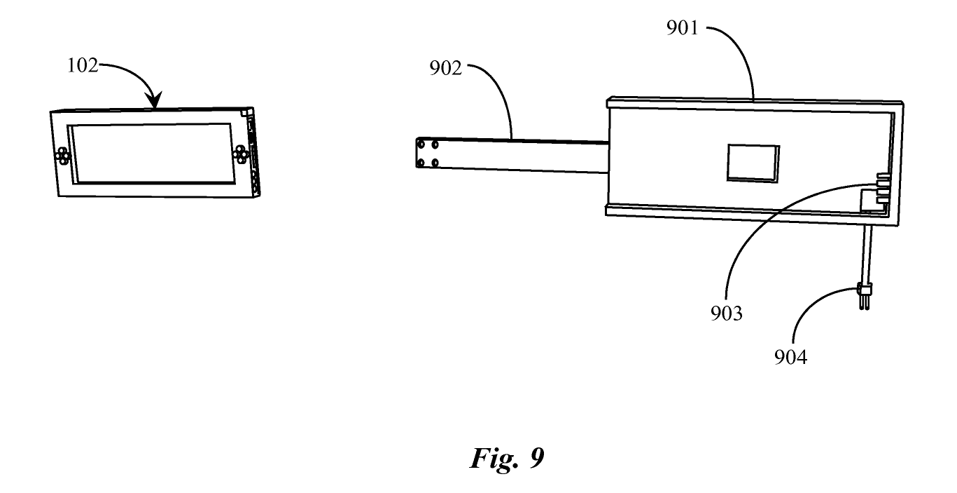

In yet another embodiment, the user may attach the PMP device to a flat screen HDTV, which is not equipped with integrated components, via an aftermarket dock 901, as is illustrated in FIG. 9. The aftermarket dock may be able to use some limited functionality of the PMP device 102. In this embodiment, the dock would piggyback onto a flat screen television, via a mounting bracket 902, and be connected to the television by way of a specialized interface port 903, that may provide similar functions to industry standard video connections, such as S-Video, Coaxial cable, RCA connectors, HDMI, or many other connection standards found in the art. The PMP device may also be powered/charged, utilizing an AC adapter 904. In this embodiment, the dock easily slides away from the flat screen television to allow the user to set recording functions, or to remove the PMP device from the dock to transport stored/recorded content. However, in this embodiment, a user is not able to continue recording onto the PMP device, once it is removed from its dock.

In the various embodiments described above, the user is able to transport their recorded television programs, access their recorded television programs, via the internet, or email recorded television programs to their friends. As a result, a new television content monetization model, whereby, the user is required to pay a monthly access fee in order to be able to transport their recorded television programs or access their content anywhere in the world. This has tremendous potential to establish a new business model for the cable and internet industries.

In another embodiment, the recorded television programs codec may be changed on the Base DVR device or the PMP device, so that the user may choose their desired/preferred playback method and/or viewing settings.

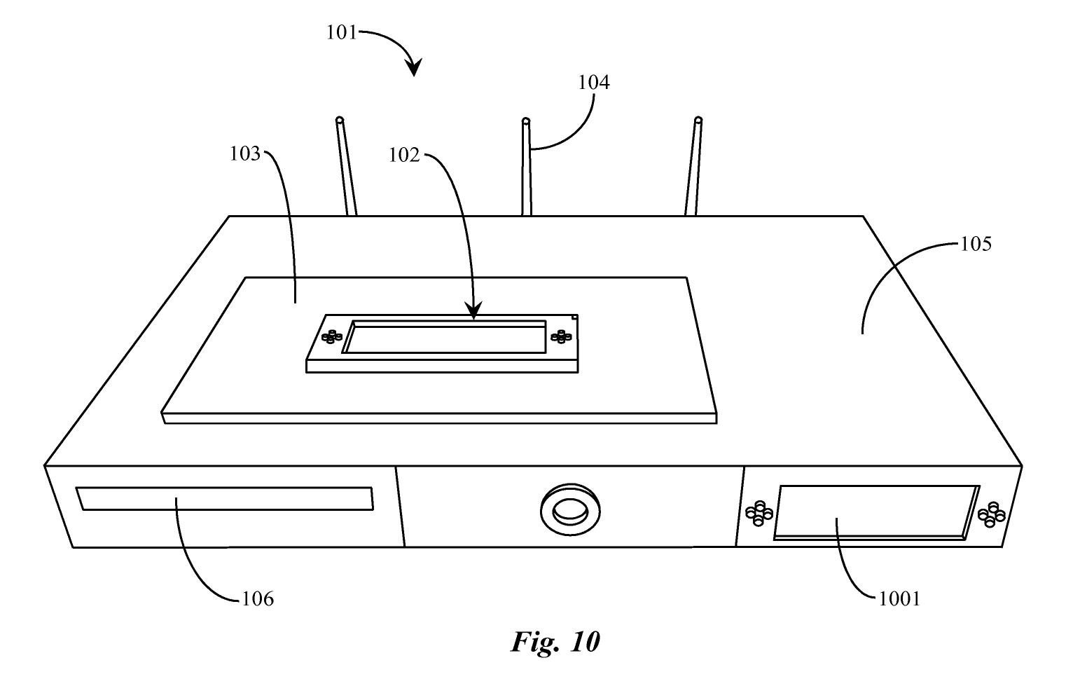

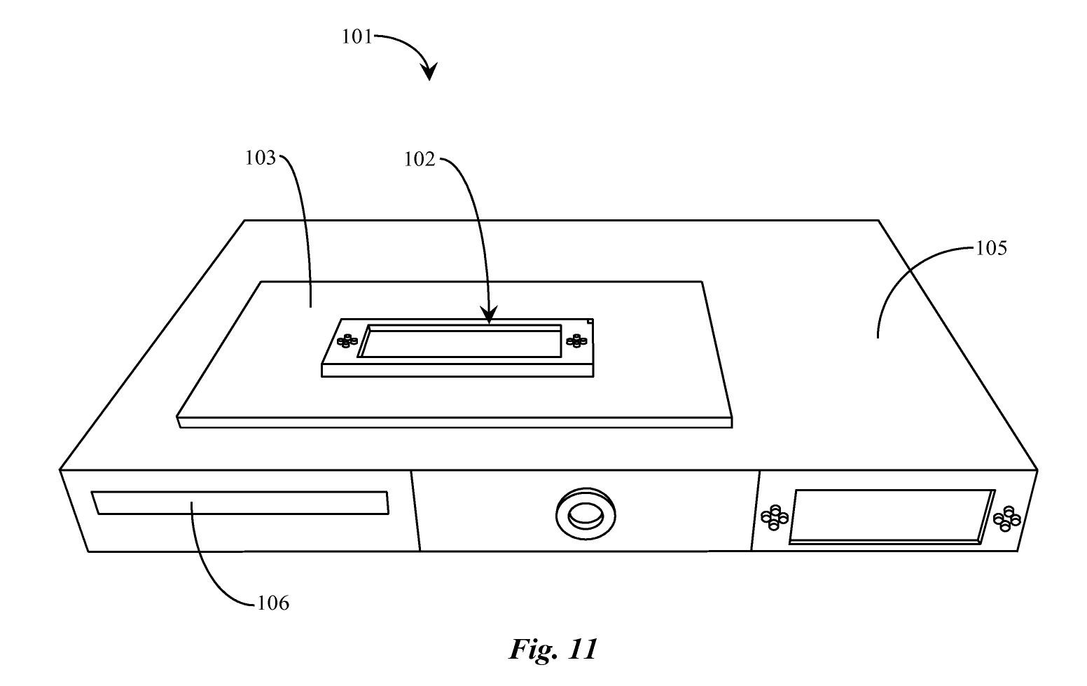

FIG. 10, and in conjunction FIG. 11, illustrate the DVR base device of FIGS. 1 and 2, with a Fixed Screen 1001, according to one embodiment of the present invention. The DVR base device may comprise all of the embodiments described above, but may also comprise a fixed screen, which the user is not able to eject from the DVR base device. The user can, however, still wirelessly pair and use the PMP device(s) with the DVR base device. The DVR base device and PMP device(s) maintain all the functionality as previously described, in the embodiments listed above. The PMP device may be charged via magnetic induction charging plate, or by plugging it into an outlet via an AC adapter, or by plugging it into a computer, laptop or DVR base device, via a USB plug.

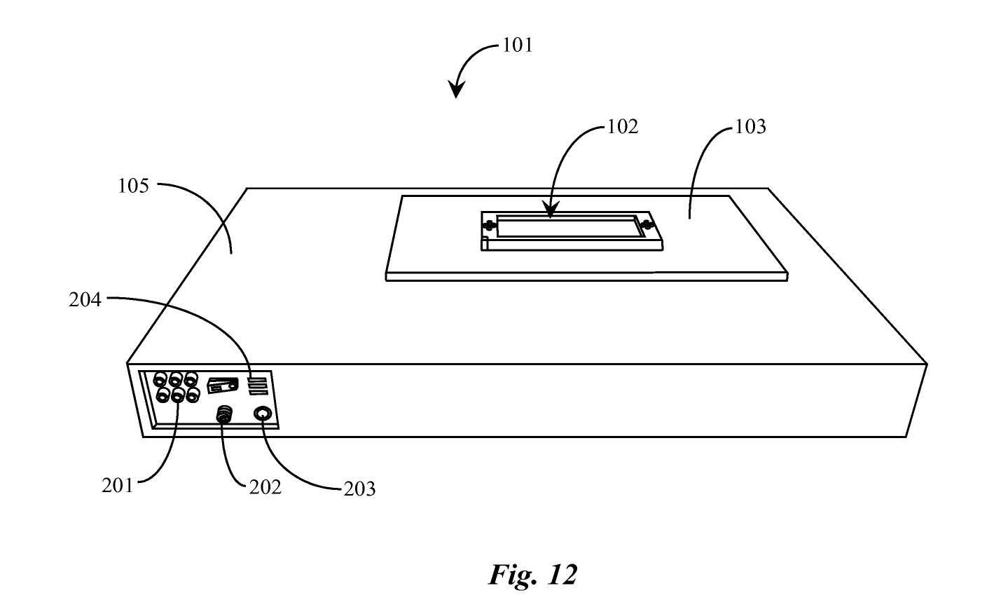

FIG. 12 illustrates the DVR base device that may comprise all of the embodiments described previously, with the exception of the wireless antennae 104, that provides connection to the internal router (refer to illustration FIG. 2), according to one embodiment of the present invention. The DVR base device maintains all the functionality listed above, but is unable to wirelessly connect to the internet. The user may however, connect to the internet by interfacing to the DVR base device, via the coaxial cable connection 202 and an integrated Internal cable modem (not shown), which may allow for ISP capabilities.

It will be apparent to a skilled artisan that the embodiments described above are exemplary of inventions that may have greater scope than any of the singular descriptions. There may be many alterations made in these examples without departing from the spirit and scope of the invention. For example, the size, shape and configuration may vary widely. The connection methods of the PMP device, portability, charging and re-charging of the PMP device, as well as the DVR interface and programming software, may be accommodated in numerous ways, known to the consumer electronics artisan. These and many other features may change in different embodiments.

1. A portable media player (PMP) comprising:
non-volatile memory;
at least one communication interface to remote digital devices;
a touch screen; and
software stored on and executing from a machine-readable physical medium;
wherein the software provides functionality to enable a user, via touch screen controls, with the PMP coupled to a digital video recorder (DVR), to browse indicators of video files stored on the DVR, to select and download files to the non-volatile memory of the PMP, and to play the video files on the touch screen of the PMP after the PMP is uncoupled from the DVR.

2. The PMP of claim 1 wherein the communication interface is compatible with a second media player, and the user is enabled to upload video files downloaded from the DVR to the second media player.
